(19) United States
(12) Patent Application Publication
(10) Pub. No.: US 2026/0098391 A1
(43) Pub. Date: Apr. 9, 2026

(54) ARRANGEMENT APPLIED TO DISMOUNTABLE MODULAR JUNCTION BOX WITH BACK PRESSURE FITTINGS

(71) Applicants: Bruno Abramo Frederico, Cotia (BR); Bruno Martini Frederico, São Paulo (BR)

(72) Inventors: Bruno Abramo Frederico, Cotia (BR); Bruno Martini Frederico, São Paulo (BR)

(21) Appl. No.: 18/721,839

(22) PCT Filed: Jun. 16, 2023
(86) PCT No.: PCT/BR2023/050199

§ 371 Date: Dec. 23, 2025

(30) Foreign Application Priority Data
Jun. 7, 2023 (BR) 2020230112612

(51) Int. Cl. E02D 29/12; H02G 9/06

(52) U.S. Cl. CPC E02D 29/124; E02D 29/121; H02G 9/06

(57) ABSTRACT

These are individual walls (1) of modular dimensions with the confronting side edges (2) enabling the beveled finish to be mounted, so that the junction of four walls (1) at 90° create a modular junction box (3), each with a groove (8) at 90° and a rib (9) at 45° that enables assembly by sliding and double locking, configuring back pressure fittings between said walls (1).

### PRIORITY STATEMENT

This patent application is National Stage application of International Application No. PCT/BR2023/050199 filed on Jun. 16, 2023 which claims the benefit and is priority of Brazil Patent Application No. 20 2023 011261 2 filed to Brazil National Institute of Industrial Property on Jun. 7, 2023, the disclosure of which is incorporated by reference herein in their entirety as part of the present application.

### BRIEF DESCRIPTION

The present application for utility model patent refers to an unprecedented “ARRANGEMENT APPLIED TO DISMOUNTABLE MODULAR JUNCTION BOX WITH BACK PRESSURE FITTINGS”, made of high resistance polypropylene for covers and varied measurements that stands out for its practicality assembling walls whose robustness is guaranteed by the male and female concept with symmetrical and opposite rib and groove juxtaposed, which guarantees fitting by back pressure.

### FIELD OF APPLICATION

The innovation claimed is applied in the construction segment in underground networks of electric energy, telecommunications, renewable energies, hydraulic, gas, among other works.

### CONVICTION

Persons skilled in the art are aware that to carry out works for passages and/or installation of cables/energy equipment/underground data there is a need to dig the soil to receive the junction boxes, whether they be concrete or pre-cast, which must be robust enough to withstand the strain of excavated ground.

Pre-cast boxes have earned increasingly greater space on the market owing to their assembly practicality, logistic streamlining and modularity.

In this context, new technologies capable of improving the use of pre-cast junction boxes making them more robust, safe and practical are welcome in the segment in question.

### STATE OF THE ART

The current state of the art anticipates some patent documents that address pre-cast junction boxes, such as U.S. Pat. No. 3,562,969 A entitled “SECTIONAL CATCH BASIN”—each base includes a groove on its upper surface along each edge, and each wall section includes a latch projecting from its lower edge, which fits into the groove of the base. The edges extending upwards of each wall include flanges and grooves that fit into the flanges and grooves of the adjacent walls. The upper ridge of each wall includes a groove and the cover which closes the upper part of the basin includes latches extending downwards along the ridges of its inner surface that project to the grooves of the walls.

The product anticipated in the document above utilizes interdependent fittings between the walls and base.

Document EP 0151905 A2 entitled “COMPOSITE CHAMBER MADE OF PVC OR OTHER POLYMER MATERIALS”—characterized by being comprised, according to a preferred embodiment, of four side walls which join together, identical and endowed with four equal sides, with bottom and cover in appropriate shapes and dimensions; since it was provided that the side walls be joined with the use of special glues, and since a perfect fitting was also provided, that these walls also present rounded side edges at 45°.

The product anticipated in the document above utilizes the 45° edges only as a guide and is joined by means of chemical adhesives.

Document GB 2270709 A1 entitled “UNDERGROUND ACCESS CHAMBER”—formed by injection molded plastic material, for example polypropylene, and is generally rectangular in shape. It may be square-shaped, but in this embodiment, it is shown as being oblong-shaped. In each of the four corners of the base there are thick portions of the vertical wall portions defining fittings in which the lower ends of the supports are received and kept. The depth of the fitting and the gap between the wall of the fitting and the surface of the supports is that that they guarantee that the ends are safely withheld in the fitting with a minimum of sideward movement.

The product anticipated in the above document uses vertical rods to assemble the walls, which is laborious and does not provide the robustness required thereby.

Document EP 0863263 A1 entitled “MODULAR DISMOUNTABLE BOX” characterized in that the modules have a slot longitudinal and rib in two of its smaller sides facing each other, designed to guarantee the join of the modules; some of the modules present the slot in the right portion and the rib in the left and other modules have a configuration symmetry with the possibility of making walls with more than one length module or corners.

In the product anticipated in the document, the modules are for overlapping, which increases the assembly and fitting time, despite the male and female type, does not provide any back pressure feature, in detriment to the robustness of the assembled box. Lastly, the fact that the modules are hollow makes it difficult to drill through-holes in them.

### OBJECTIVES OF THE INNOVATION

It is an objective of the present innovation to propose an arrangement applied to the dismountable modular junction box with back pressure fittings capable of guaranteeing, by means of double locking on the faces of the opposing walls, better fastening, sealing and greater robustness of the assembled box.

It is an objective of the present innovation to propose an arrangement applied to the dismountable modular junction box with back pressure fittings capable of promoting greater practicality in assembly since the modules are one-piece, there being no need for overlapping fittings.

It is an objective of the present innovation to propose an arrangement applied to the dismountable modular junction box with back pressure fittings which since the walls are unique enable through-holes to be made utilizing drills or hole saws, for the passage of cables without the risk of weakening, since the honeycombs and/or ribs structure the product.

It is an objective of the present innovation to propose an arrangement applied to the dismountable modular junction box with versatile back pressure fittings, because in the event of the need to adjust the height of the module, it is sufficient to use a cutting tool.

It is an objective of the present innovation to propose an arrangement applied to the dismountable modular junction box with light back pressure fittings that are easy to transport and provide a logistical gain.

It is an objective of the present innovation to propose an arrangement applied to the dismountable modular junction box with back pressure fittings providing excellent cost vs. benefit ratio.

### SUMMARY OF THE INNOVATION

The “ARRANGEMENT APPLIED TO DISMOUNTABLE MODULAR JUNCTION BOX WITH BACK PRESSURE FITTINGS”-formed by unique individual walls, modules in different dimensions both in height as in length, duly tempered by honeycombs and/or ribs with emphasis on the side faces that shape a groove and a rib making a double locking configuring back pressure fittings between said walls.

The height of the junction box satisfies different project needs and may vary from 600×600×500/2000 mm (L-L-H); 600/750×800/950×500/2000 mm (L L-H); 600/750×1000/1150×500/2000 mm (L-L-H); 800×800×500/2000mm (L L-H); 800/950×1000/1150×500/2000 mm (L-L-H) and 1000×1000×500/ 2000 mm (L-L-H).

### DRAWINGS OF THE INNOVATION

Next are the drawings to further explain the patent application in an illustrative, non-limiting manner:

FIG. 1: Perspective view of the arrangement applied to versatile dismountable modular junction box with back pressure fittings, with blown-up detail of the edges.

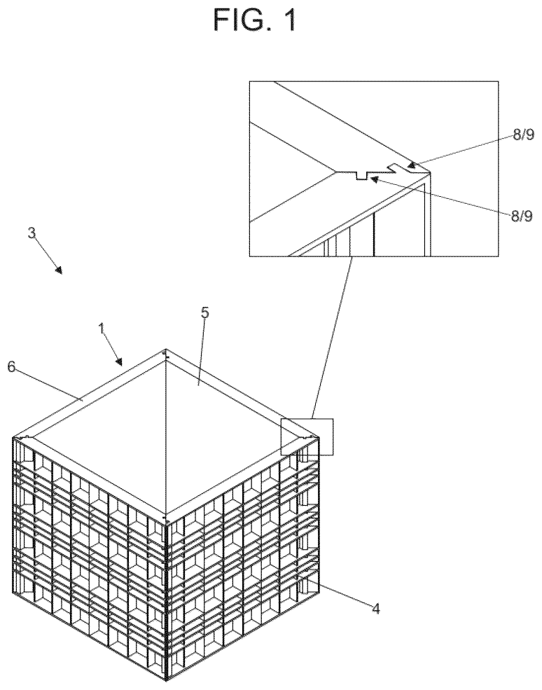

FIG. 2: Inverted perspective view of the arrangement applied to dismountable modular junction box with versatile back pressure fittings.

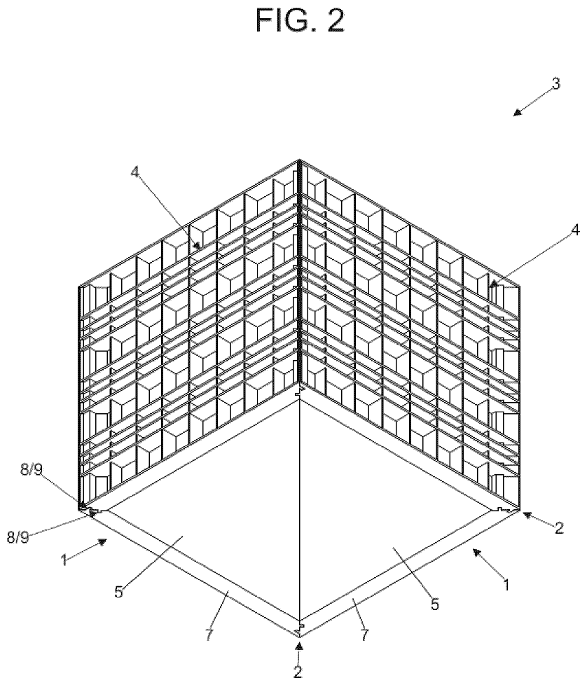

FIG. 3: Blown-up perspective view of the arrangement applied to dismountable modular junction box with versatile back pressure fittings.

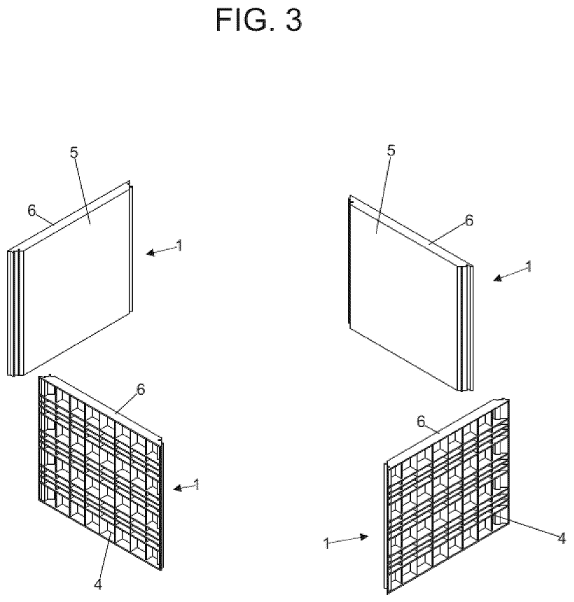

FIG. 4: Top view of the arrangement applied to dismountable modular junction box with versatile back pressure fittings.

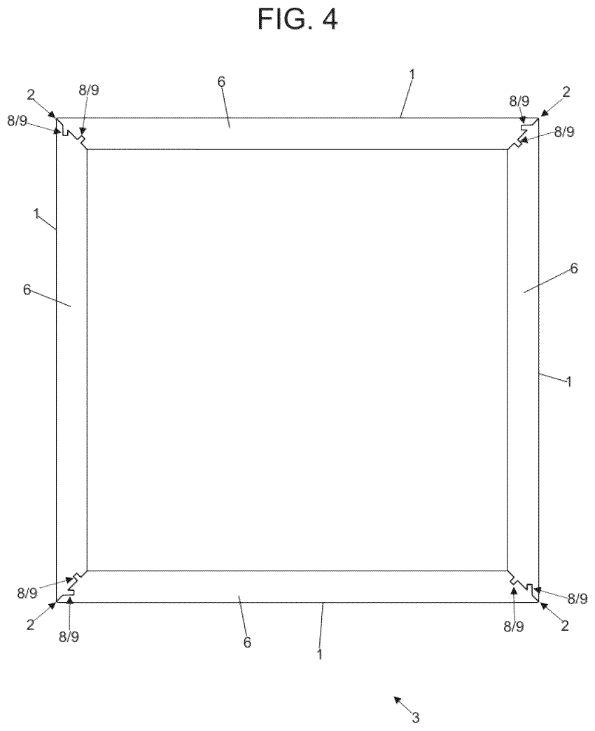

FIG. 5: Bottom view of the arrangement applied to dismountable modular junction box with versatile back pressure fittings.

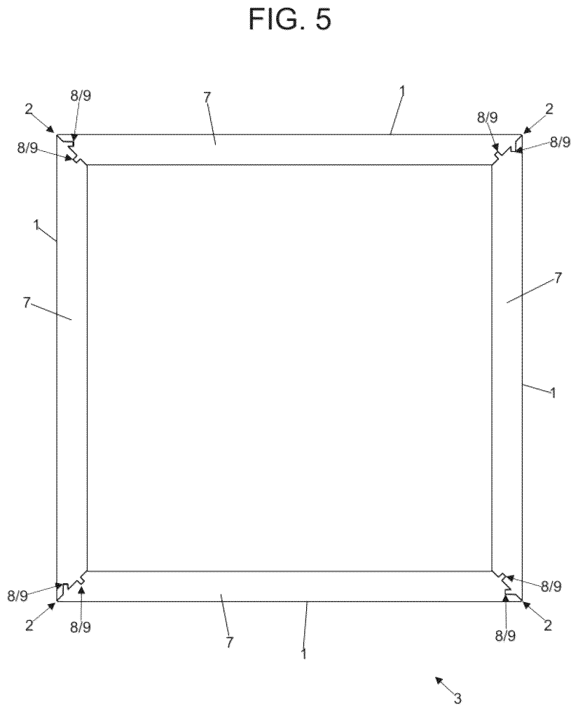

FIG. 6: Perspective view of the wall of the arrangement applied to dismountable modular junction box with versatile back pressure fittings.

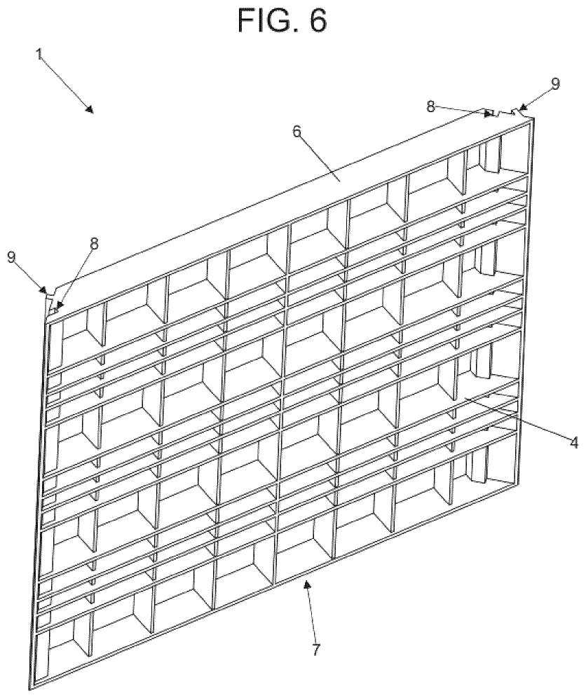

FIG. 7: Inverted perspective view of the wall of the arrangement applied to dismountable modular junction box with versatile back pressure fittings.

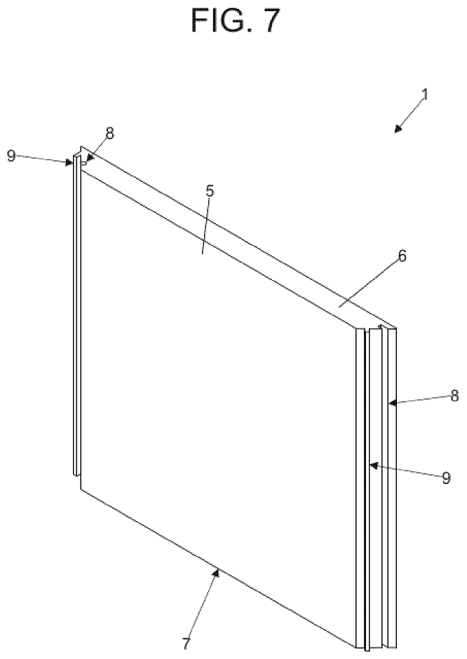

FIG. 8: Perspective view of the wall of the arrangement applied to dismountable modular junction box with versatile back pressure fittings, showing slide fit.

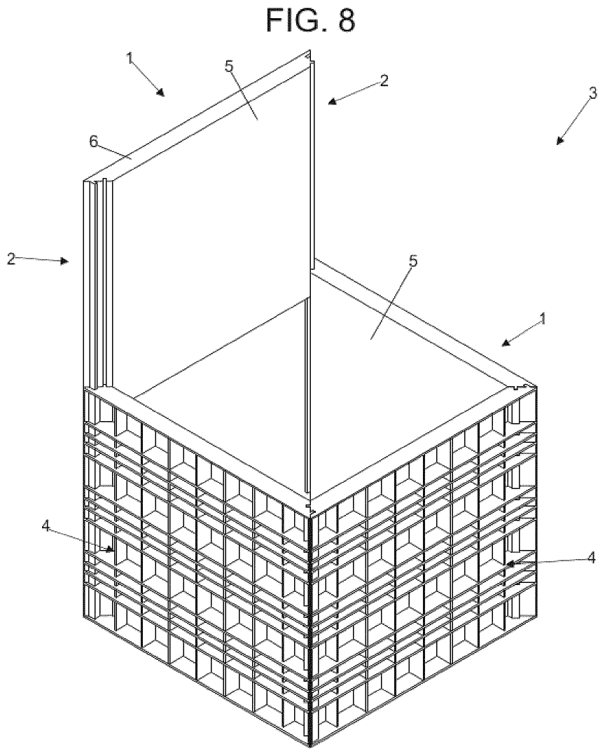

FIG. 9: Perspective view of the wall of the arrangement applied to dismountable modular junction box with versatile back pressure fittings, mounted with cover.

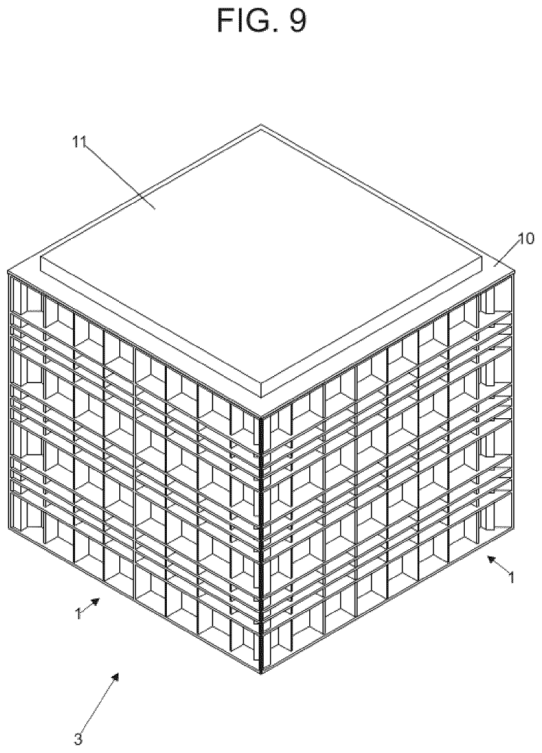

### DETAILED DESCRIPTION OF THE INNOVATION

The “ARRANGEMENT APPLIED TO A DISMOUNTABLE MODULAR JUNCTION BOX WITH BACK PRESSURE FITTINGS”, the object of this application for utility model patent refers to individual walls (1), of modular dimensions with the confronting side edges (2) enabling the beveled finish to be mounted, so that the junction of four walls (1) at 90° create a modular junction box (3), each with a groove (8) at 90° and a rib (9) at 45° that enables assembly by sliding and double locking, configuring back pressure fittings between said walls (1).

More particularly, the utility model consists of an “arrangement applied to dismountable modular junction box with back pressure fittings” formed by individual walls (1), of modular dimensions according to usage needs, made of high resistance polypropylene with the confronting side edges (2) that enable the beveled finish to be mounted, so that the junction of four walls (1) at 90° create a modular junction box (3). Externally, the walls (1) present honeycombs (4) and or structural ribs duly spaced and internally have a predominantly smooth surface (5), creating an inset with the upper line (6) and the flat lower line (7), whereas the side edges (2), left and right, have chamfered, symmetrical and opposite finishes, each with a groove (8) at 90° and a rib (9) at 45°, which besides enabling and assembly by sliding also provides a double locking in these sections, configuring back pressure fittings between said walls (1), as well as better fastening, sealing and greater robustness to the junction box (3) when assembled. Since walls are unique and structured with honeycombs (4) and or ribs, it is possible to make holes with drills or hole saws in any region of their surfaces with ease, agility and without causing any physical damage to the product. In the same way, it is possible to make adjustments to the height of the walls with the use of cutting tools.

With the modular junction box (3) duly mounted, it is suffice to position a metal inset (10) to receive the finishing cover (11) easily accessible inside the product.

1. (canceled)

2. A junction for adjoining surfaces of a modular assembly, comprising:
modular walls formed by individual walls having modular dimensions according to usage needs, made of high-resistance polypropylene;
adjoining surfaces at the junction of the modular walls, wherein the adjoining surfaces comprise a groove disposed at 90° and a rib disposed at 45°, the groove and rib extending along a length of the adjoining surface;
the modular walls having confronting side edges with chamfered, symmetrical, and opposite finishes, the side edges configured to form back pressure fittings between the modular walls;
the junction of the modular walls creating a modular assembly; and
wherein adjustments to the height of the modular walls are performed using cutting tools.

3. The junction for adjoining surfaces of a modular assembly according to claim 2, wherein an additional adjoining surface of the modular walls includes a groove disposed at 45° and a rib disposed at 90°, the groove and rib extending along the length of the adjoining surface to create additional back pressure fittings between the modular walls.

4. The junction for adjoining surfaces of a modular assembly according to claim 2, wherein the modular assembly comprises a plurality of modular walls removably connected at the adjoining surfaces, the connection at the adjoining surfaces creating a modular junction box.

5. The junction for adjoining surfaces of a modular assembly according to claim 2, wherein the adjoining surfaces of the modular walls comprise mating beveled adjoining surfaces.

6. The junction for adjoining surfaces of a modular assembly according to claim 2, wherein the adjoining surfaces of the modular walls comprise mating symmetrical adjoining surfaces.

7. The junction for adjoining surfaces of a modular assembly according to claim 2, wherein at least one of the modular walls comprises opposing side edges with one of the adjoining surfaces of the junction.

8. The junction for adjoining surfaces of a modular assembly according to claim 3, wherein at least one of the modular walls comprises opposing side edges with the other one of the adjoining surfaces of the junction.

9. A method for adjoining surfaces of a modular assembly at a junction, comprising:
providing modular walls having modular dimensions according to usage needs, the modular walls formed of high-resistance polypropylene and comprising opposing side edges;
providing adjoining surfaces at the junction of the modular walls, wherein the adjoining surfaces comprise a groove disposed at 90°and a rib disposed at 45°, the groove and rib extending along a length of the adjoining surface;
connecting the modular walls at the adjoining surfaces by sliding the ribs into the grooves, thereby creating back pressure fittings between the modular walls; and
forming a modular junction box from the connected modular walls.

10. The method according to claim 9, further comprising:
assembling a modular junction box by sliding the ribs into the grooves at the junction until the opposing side edges of the connected opposing modular walls are flush with each other.

11. The method according to claim 9, wherein the grooves and ribs on the adjoining surfaces extend continuously along the entire length of the modular walls.

12. The method according to claim 9, further comprising:
adjusting the height of the modular walls by cutting along a plane parallel to the opposing side edges.

13. A modular junction box assembled from the modular walls according to the method of claim 9.
